(19) United States
(12) Patent Application Publication
(10) Pub. No.: US 2025/0042471 A1
(43) Pub. Date: Feb. 6, 2025

(54) STEERING KNUCKLE FOR INCREASING GROUND CLEARANCE OF A VEHICLE

(71) Applicants: Varun Prasad, Frisco, TX (US); Bobby Wayne Hale, Bastrop, TX (US)

(72) Inventors: Varun Prasad, Frisco, TX (US); Bobby Wayne Hale, Bastrop, TX (US)

(21) Appl. No.: 18/474,025

(22) Filed: Sep. 25, 2023

Related U.S. Application Data
(63) Continuation-in-part of application No. 18/229,601, filed on Aug. 2, 2023, now abandoned.

(51) Int. Cl. B62D 7/18

(52) U.S. Cl. CPC B62D 7/18

(57) ABSTRACT

A steering knuckle for increasing ground clearance of a vehicle is disclosed. The steering knuckle includes a vertical arm, an upper mount, a steering arm and a lower mount positioned at the vertical arm. The steering knuckle includes a hub positioned at the bottom of the vertical arm. The upper mount includes an upper control arm. The lower mount includes a lower control arm. The hub mounts outside of attachment points of the upper control arm and the lower control arm in order to keep the same distance between the upper mount and the lower mount, and the steering arm to maintain a factory geometry.

### RELATED APPLICATIONS AND CLAIM FOR PRIORITY

The present application is a continuation-in-part of a U.S. patent application Ser. No. 18/229,601, filed Aug. 2, 2023; and a U.S. Provisional Patent Application No. 63/346,257 filed May 26, 2022; all of which are incorporated herein in their entirety and referenced thereto.

### TECHNICAL FIELD

The present disclosure relates to steering apparatus in a vehicle, and in particular, relates to a steering knuckle for increasing ground clearance of a vehicle such as a large pickup truck.

### DESCRIPTION OF THE RELATED ART

It is known that a steering apparatus of a vehicle allows a driver to steer a vehicle in a desired direction. The steering apparatus includes a steering wheel, a steering shaft, a gear unit, and a link structure. The link structure includes a steering knuckle having a wheel hub that attaches to a suspension and the gear unit.

An example of a steering knuckle is shown in FIG. 1, as known in prior art. FIG. 1 shows a top view and a perspective view respectively of a typical steering knuckle 10, as known in prior art. Steering knuckle 10 includes a body 12, and a vertical arm (not shown) extending upwards from body 12. The vertical arm presents a strut arm 16, a steering arm 18 and a tie rod arm 20. Further, steering knuckle 10 includes a hub mount 22 for a mounting assembly (not shown) to connect steering knuckle 10 to a vehicle (not shown).

Another steering knuckle is disclosed in a United States Granted U.S. Pat. No. 6,419,250, entitled “One-piece forged steering knuckle assembly” (“the '250 Patent”). The '250 Patent discloses a knuckle assembly for vehicles having a flanged body wherein the tie rod arm, hydraulic brake caliper bracket and, in some instances, the steering arm extend from the flanged body in a one-piece forged manner. There are enlarged bosses extending from the flanged body opposite the wheel spindle, the bosses having a bore which are axially aligned to receive a king pin. The flanged body, wheel spindle, tie rod arm and brake caliper bracket are all formed from a single steel billet as a one-piece heavy duty forging. Such a design eliminates the brake caliper/knuckle joint and the tie rod arm/knuckle joint, and thus, it results in savings in assembly time and weight.

Although the above discussed disclosures are useful, they have few problems. For example, existing steering knuckles do not allow to increase the ground clearance of the vehicle. Even if a user wishes to increase the ground clearance, then the size of the vehicle has to be stretched vertically. This may increase the ground clearance, but the wheels still have to touch the ground, and the frame of the vehicle has to be raised. Doing so puts a lot of stress on steering system components as they are now pulled to a strange angle, and this will cause them to wear out faster.

Therefore, there is a need in the art to provide an improved steering knuckle designed for large vehicles to increase the ground clearance by several inches.

### SUMMARY

It is an object of the present invention to provide a steering knuckle designed for large vehicles that avoids the drawback of known steering knuckles.

It is another object of the present invention to provide a steering knuckle designed for large vehicles to increase the ground clearance by several inches.

In order to achieve one or more objects, the present invention provides a steering knuckle for increasing ground clearance of a vehicle. The steering knuckle includes a vertical arm, an upper mount, a steering arm and a lower mount positioned at the vertical arm. The upper control arm includes dual upper control mounts having dual reservoir shock mounts. The lower control arm includes dual lower control mounts. The steering knuckle includes a hub positioned at the bottom of the vertical arm. The upper mount includes an upper control arm. The lower mount includes a lower control arm. The hub mounts outside of attachment points of the upper control arm and the lower control arm in order to keep the same distance between the upper mount and the lower mount, and the steering arm to maintain a factory geometry.

The hub is placed just below and outside of the lower control arm such that ⅓rd of a wheel is in line with a hub assembly and increases ground clearance of a vehicle. The steering knuckle includes vertical ribs to meet at the back of the hub at 45 degrees to create a point that distributes both vertical force and lateral force evenly between the upper control arm and the lower control arm as if the hub remained in its factory geometry.

The steering knuckle includes an access panel to provide access to the interior of the steering knuckle. The access panel includes a gear mechanism that transfers motion from a vehicle's constant velocity (CV) shaft to a vehicle's wheel. Further, the steering knuckle includes a power train unit that transfers power from internal mechanisms of the steering knuckle into a hub assembly through the use of a pinion and spider gears of the gear mechanism.

In one advantageous feature of the present invention, the steering knuckle is designed for lifted trucks, i.e., for large pickup trucks to which an after-market modification can be made to increase the ground clearance by several inches.

In another advantageous feature of the present invention, the steering knuckle can be used with a two-wheel-drive (2WD) vehicle, and/or a four-wheel-drive (4WD) vehicle, with gears or a chain to transfer motion from the vehicle's constant velocity (CV) shaft to the wheels.

The features and advantages of the invention here will become more apparent in light of the following detailed description of selected embodiments, as illustrated in the accompanying FIGURES. As will be realized, the invention disclosed is capable of modifications in various respects, all without departing from the scope of the invention. Accordingly, the drawings and the description are to be regarded as illustrative in nature.

### BRIEF DESCRIPTION OF THE DRAWINGS

The present invention will now be described in detail with reference to the drawings, which are provided as illustrative examples of the invention so as to enable those skilled in the art to practice the invention. Notably, the FIGURES and examples are not meant to limit the scope of the present invention to a single embodiment, but other embodiments are possible by way of interchange of some or all of the described or illustrated elements and, further, wherein:

FIG. 1 illustrates a top view of a steering knuckle, in accordance with prior art;

FIG. 2 illustrates an environment in which a steering knuckle implements, in accordance with one embodiment of the present invention;

FIGS. 3A and 3B illustrate a perspective view and a side view, respectively of the steering knuckle, in accordance with one embodiment of the present invention;

FIG. 4 illustrates the steering knuckle comprising a gear mechanism, in accordance with one embodiment of the present invention;

FIG. 5 illustrates the steering knuckle comprising a power train unit, in accordance with one embodiment of the present invention;

FIG. 6 illustrates the steering knuckle comprising a camber, in accordance with one embodiment of the present invention;

FIG. 7 illustrates a perspective view of a steering knuckle, in accordance with another embodiment of the present invention;

FIG. 8 illustrates the steering knuckle comprising a gear mechanism, in accordance with one embodiment of the present invention;

FIG. 9 illustrates a top view of an upper control arm of the steering knuckle, in accordance with one embodiment of the present invention;

FIG. 10 illustrates a side view of a dual reservoir shock mount, in accordance with one embodiment of the present invention;

FIG. 11 illustrates a front view of a ball joint conversion adapter that inserts in the upper control arm, in accordance with one embodiment of the present invention;

FIG. 12 illustrates a top view of a lower control arm of the steering knuckle, in accordance with one embodiment of the present invention; and

FIG. 13 illustrates a front view of a ball joint conversion adapter that inserts in the lower control arm, in accordance with one embodiment of the present invention.

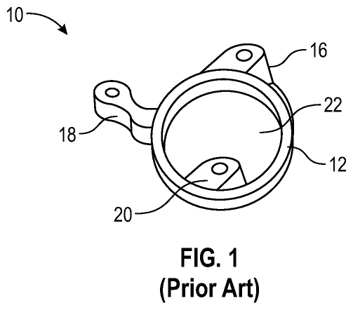

### DETAILED DESCRIPTION

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed steering knuckle. However, it will be apparent to those skilled in the art that the presently disclosed invention may be practiced without these specific details. In some instances, well-known structures and devices are shown in functional or conceptual diagram form in order to avoid obscuring the concepts of the presently disclosed steering knuckle.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention provides a description of a steering knuckle, it is to be further understood that numerous changes may arise in the details of the embodiments of the steering knuckle. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

The present invention discloses a steering knuckle for increasing ground clearance of a vehicle. The steering knuckle includes a vertical arm, an upper mount, a steering arm and a lower mount positioned at the vertical arm. The steering knuckle includes a hub positioned below the vertical arm. The upper mount includes an upper control arm. The lower mount includes a lower control arm. The hub mounts outside of attachment points of the upper control arm and the lower control arm in order to keep the same distance between the upper mount and the lower mount, and the steering arm to maintain a factory geometry. The hub is placed of just below the lower control arm such that ⅓rd of a wheel is in line with a hub assembly and increases ground clearance of a vehicle.

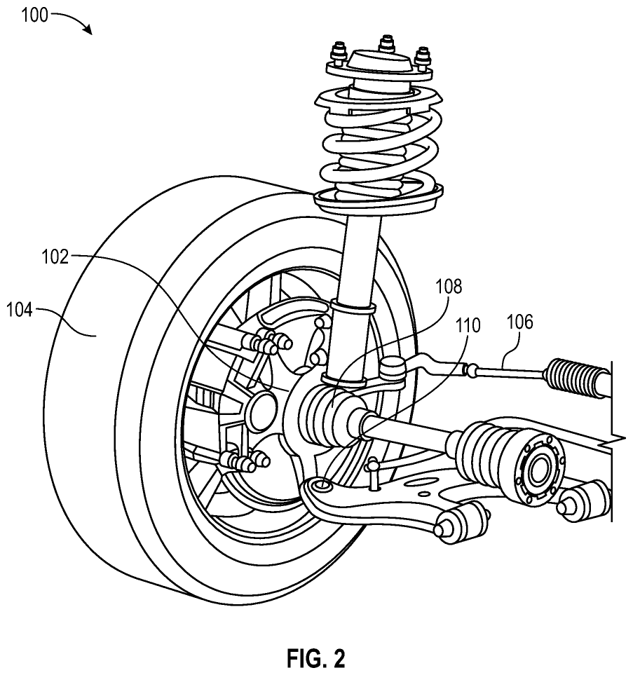

Various features and embodiments of a steering knuckle for increasing ground clearance are explained in conjunction with the description of FIGS. 2-13.

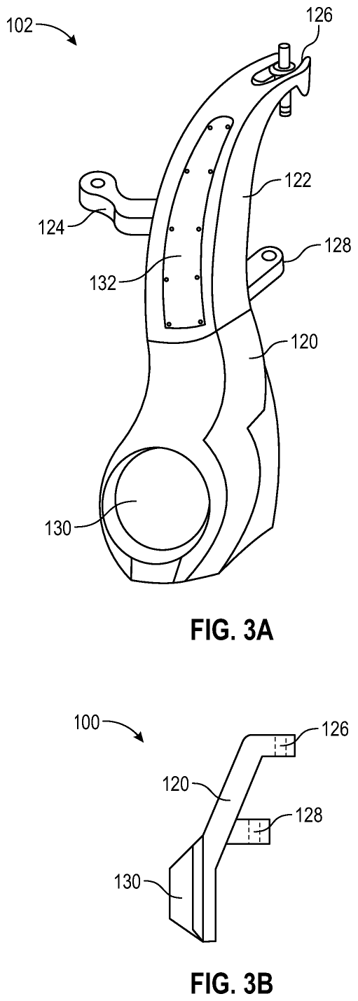

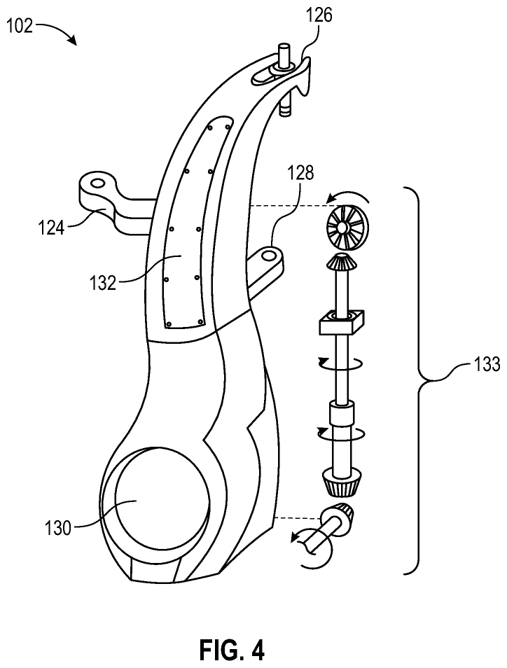

FIG. 2 shows an environment 100 in which a steering knuckle 102 implements, in accordance with one embodiment of the present invention. In other words, environment 100 shows an embodiment of the invention appropriate for a rear-wheel drive vehicle 104; that is, a vehicle in which the drivetrain's power does not need to be translated through to a hub assembly 108. As can be seen, steering knuckle 102 connects to a wheel 104. Further, steering knuckle 102 connects to a steering arm 106, a hub assembly 108 and a tie rod arm 110. FIGS. 3A and 3B show a perspective view of steering knuckle 102, in accordance with one embodiment of the present invention. Steering knuckle 102 includes a body 120. Body 120 includes a vertical arm 122. Vertical arm 122 presents a steering arm 124, an upper mount 126, and a lower mount 128. Further, body 120 includes a hub 130 at the bottom. Hub 130 receives hub assembly 108, as shown in FIG. 2. Further, body 120 includes an access panel 130. Access panel 130 indicates a door-like structure allowing or restricting access to a gear mechanism 133 stored within body 120. FIG. 4 shows an exploded view of gear mechanism 133 inside access panel 130.

In accordance with the present invention, upper mount 126 presents an upper control arm (UCA) 134. Further, lower mount 128 presents a lower control arm (LCA) 136. UCA 134 allows connecting dual upper control mounts 138 at upper mount 126, as shown in FIG. 4. Further, LCA 136 connects dual lower control mounts 140 at lower mount 128.

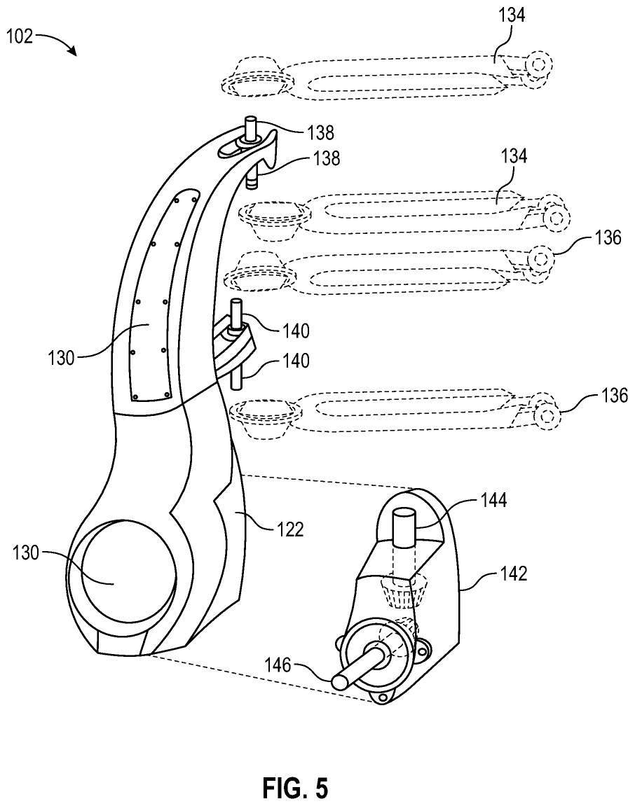

Further, body 120 includes a power train unit (PTU) 142, as shown in FIG. 5. PTU 142 includes a casing that houses a first splined input shaft 144 and a second splined input shaft 146. First splined input shaft 144 connects to gear mechanism 133. Second splined input shaft 146 has a shape that matches with a factory hub setting and connects to any hub assembly 108. In the present invention, PTU 142 transfers power from internal mechanisms of knuckle into factory hub assembly 108 through the use of a pinion and spider gears of gear mechanism 133 via solid axles (not shown), available in vehicles.

Additionally, each of upper mount 126 and lower mount 128 includes a camber or caster alignment adjustment member 148. FIG. 6 shows an enlarged view of camber 148, in accordance with one embodiment of the present invention. Caster 148 includes a connector 150. In one example, connector 150 includes a Heim joint, or spherical Heim bearing rod end, or a pivot connector. Camber 148 helps to adjust the alignment of both dual upper control mounts 138 at upper mount 126, and dual lower control mounts 140 at lower mount 128. In the present invention, placement of camber on the knuckle and at both upper mount 126 and lower mount 128 makes for a much greater range of camber and caster degrees. Further, camber 148 allows for better alignment for oversized wheel 104 and tire combinations.

In the present invention, hub 130 is located outside of the attachment points i.e., UCA 134 and LCA 136 (upper and lower control arm ball joints). This allows the steering knuckle to keep the same distance between upper mount 126, and lower mount 128, and steering arm 124 to maintain factory geometry. When compared with the prior art, conventional designs place the hub at the center suspended between two fixed points. Further, the conventional lifted suspension designs move the control arms apart then enlarge the steering knuckle proportionally to fit the new space in order to maintain the alignment.

In accordance with the present invention, steering knuckle 102 can be mounted to a rear-wheel drive vehicle (two-wheel drive vehicle) and a four-wheel drive vehicle (all wheel drive vehicle). In order to connect to a rear-wheel drive vehicle (two-wheel drive vehicle), at first, hub 130 is mapped from its factory/stock location centered between UCA 134 and LCA 136 to a final placement of just below LCA 136 such that ⅓rd of the overall wheel is in line with the lower ball joint. The final location of hub 130 is positioned out and away from the vehicle. Placing hub 130 out and down increases ground clearance and guarantees there is no contact with the caliper on LCA 136 when the knuckle turns right or left. Most manufacturers prevent this caliper contact by placing a “steer strap” on the knuckle, but such a technique causes a reduction in the steering radius. In order to address the above problem, a 4″ knuckle is used as the starting point to build the presently disclosed steering knuckle. First, the lifted knuckle provides more mass and material with which to work. Second, it is difficult to expect a fabricator to accurately replicate/obtain the correct dimensions of the depth of the mounting holes and placement of the hub seat in relation to the caliper mount. It is also unrealistic to expect a fabricator to accurately construct a custom hub seat.

In the present invention, hub 130 is removed from its factory location centered between the UCA 134 and LCA 136. From the 4″ lifted knuckle, steering arm 124, upper mount 126, and lower mount 128 are removed. Further, a CNC machine is used to mill down what remains until it is no more than a basic mounting plate for the hub and caliper (at this point, all the original mounts and features are removed). The location of the original UCA mount becomes the location of the new LCA mount.

Further, two standing vertical ribs are provided to meet the back of the hub at 45 degrees' angles (as shown in FIG. 3B) thus creating a point that distributes both vertical force and lateral force evenly between UCA 134 and LCA 136 as if hub 130 had remained in its factory location. An internal top view of the neck shows the same geometric redundancies as those seen in a trestle bridge. Furthermore, two deep channels are cut into the back of the mounting plate for each of the two standing ribs (the side plates). Finally, the notches are provided with the same width as the channels in the plate steel standing ribs are cut into the cast steel hub. Further, the hub is slid along the channel and welds it into place.

In order to use the steering knuckle 102, hub assembly 108 is unscrewed and a lift knuckle is mounted LCA 136 and hub assembly 108 is fitted into the lift knuckle.

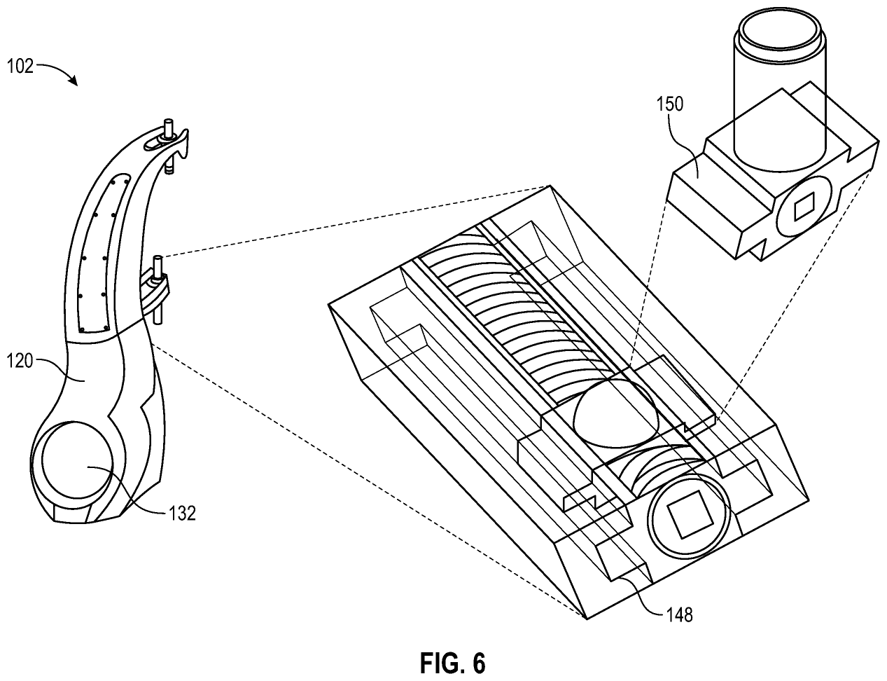

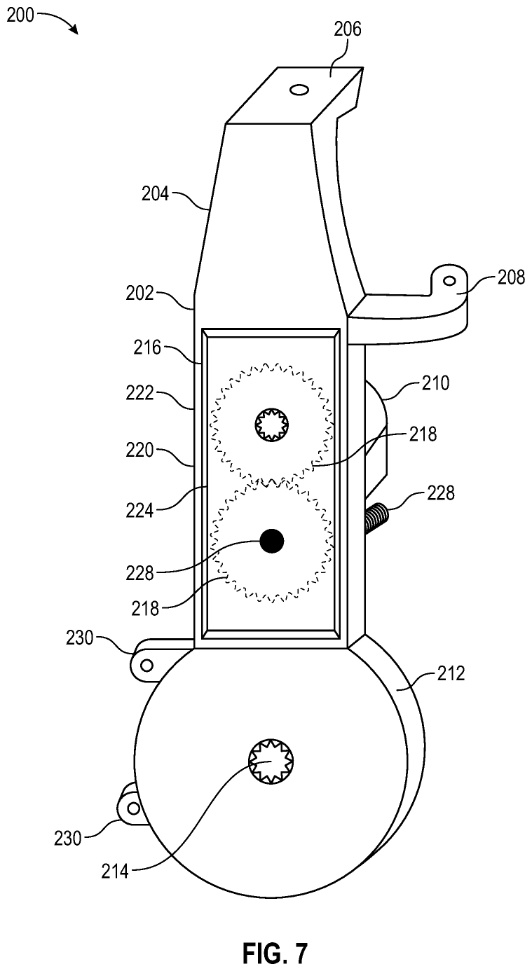

FIG. 7 shows a schematic diagram of a steering knuckle 200, in accordance with another embodiment of the present invention. Steering knuckle 200 includes a body 202. Body 202 has a vertical arm 204 presenting an upper mount 206, a steering arm 208 and a lower mount 210. Further, body 202 includes a hub 212 having a four-wheel drive power input 214.

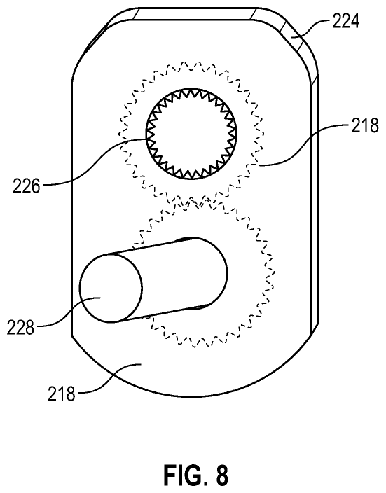

Additionally, steering knuckle 200 includes an access panel 216 housing a gear mechanism 218. Gear mechanism 218 includes an axle input 220. Body 202 and an access panel 216 present a hollow area 222. In one example, gear mechanism 218 is housed in a casing 224. FIG. 8 shows the feature of casing 224, in accordance with one embodiment of the present invention. In one example, gear mechanism 218 has a female splined input 228 and a male splined output 228. As can be seen in FIG. 8, male splined output 228 extends from casing 224. Further, hub 212 includes caliper mounts 230, as shown in FIG. 7.

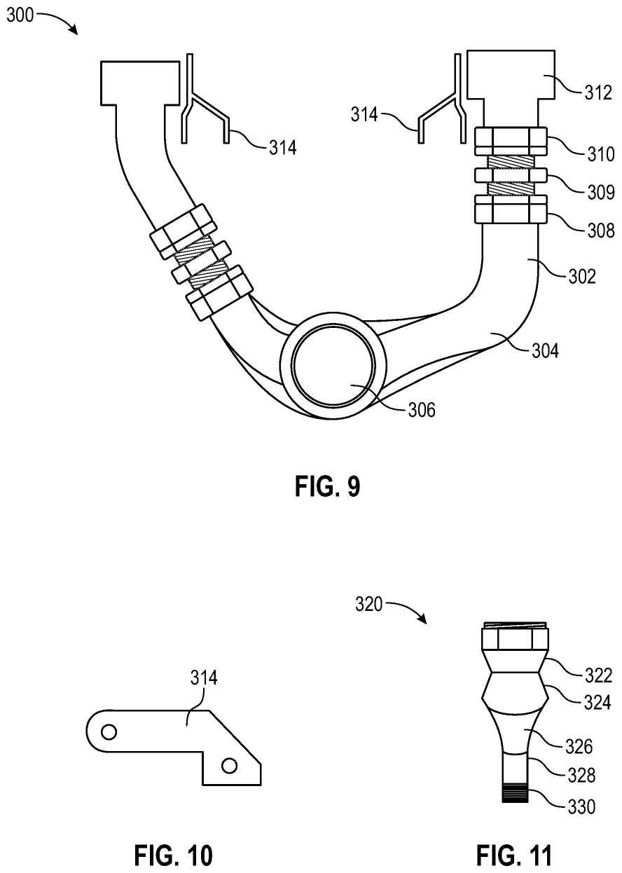

In the present embodiment, upper mount 206 includes an upper control arm (UCA) 300, as shown in FIG. 9. UCA 300 operates similarly to UCA 134, as explained above. Here, UCA 300 includes a U-shaped member 302 having a curved section 304. U-shaped member 302 aligns with upper mount 206. Further, UCA 300 includes a connector 306 i.e., a Heim joint to receive a Heim or ball joint conversion adapter 320. Further, U-shaped member 302 has adjustment locking nuts 308, 310 substantially at center. In one example, locking nuts 308, 310 have a welded camber or caster adjustment nut 309 in between them. Camber 309 helps to adjust the length of arms of U-shaped member 302.

U-shaped member 302 includes an upper control arm mount 312 at distal ends. Here, upper control arm mount 312 helps to mount steering suspension at factory settings. In one example, upper control arm mount 312 includes dual reservoir shock mounts 314. FIG. 10 shows a side view of dual reservoir shock mounts 314, in accordance with one embodiment of the present invention. Dual reservoir shock mounts 314 indicate shock mounting brackets that absorb vibrations caused during the operation. A person skilled in the art understands that dual reservoir shock mounts 314 can be replaced with any shock body mounting apparatus that is known in the art.

Further, UCA 300 includes an adapter 320 that connects UCA 300 to a steering knuckle. FIG. 11 shows a side view of adapter 320, in accordance with one embodiment of the present invention. As specified above, adapter 320 includes a Heim or ball joint conversion adapter 320. Adapter 320 has a first conical nut 322. Further, adapter 320 has a first tapered section 324 that matches the Heim joint i.e., connector 306. First tapered section 324 extends from conical nut 322. Adapter 320 has a second tapered section 326 that extends from first tapered section 324. Second tapered section 326 matches the diameter of the Heim joint i.e., connector 306 at the bottom. Adapter 320 has a conical section 328 extending further down from second tapered section 326 Conical section 328 goes through connector 306 and allows adapter 320 to sit within connector 306. Further, adapter 320 has a threaded portion 330 extending from conical section 328.

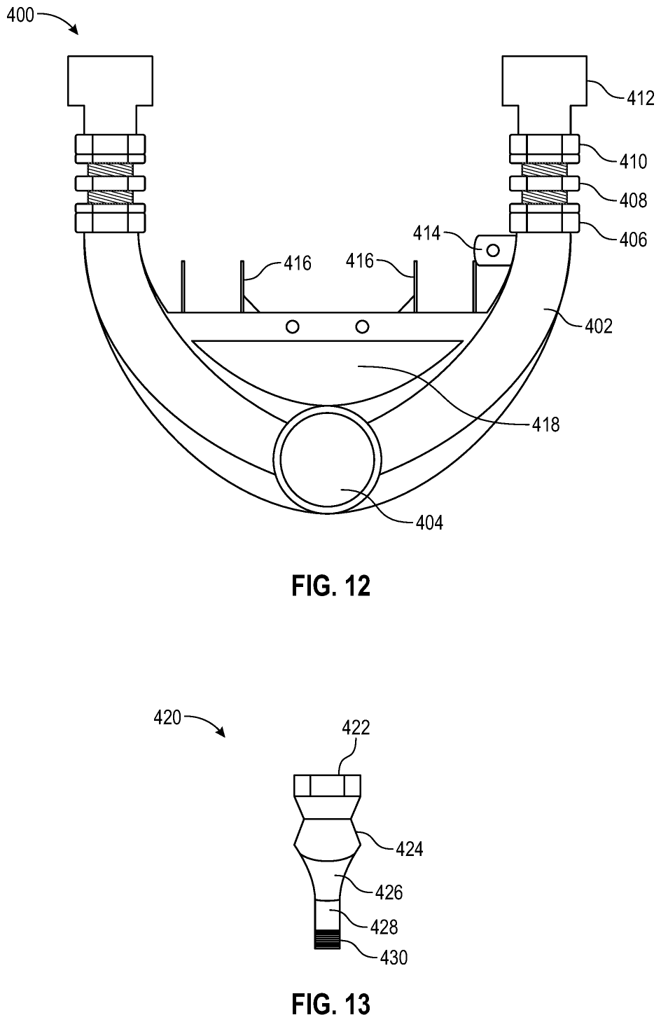

Referring back to FIG. 7, lower mount 210 includes a lower control arm (LCA) 400, as shown in FIG. 12. LCA 400 operates similar to LCA 136, as explained above. Here, LCA 400 includes a U-shaped member 402. U-shaped member 402 aligns with lower mount 210. Further, LCA 400 includes a connector 404 i.e., Heim joint to receive a Heim or ball joint conversion adapter 420. Further, U-shaped member 402 has adjustment locking nuts 406, 410 substantially at center. In one example, locking nuts 406, 410 have a welded camber or caster adjustment nut 408 in between them. Camber 408 helps to adjust the length of arms of U-shaped member 402.

U-shaped member 402 includes lower control arm mounts 412 at distal ends. Here, lower control arm mount 412 helps to mount steering suspension at factory settings. In one example, U-shaped member 402 includes a sway bar mount 414. Optionally, U-shaped member 402 includes an additional shock mount 316. Further, U-shaped member 402 includes strut mount 418.

Further, LCA 400 includes an adapter 420 that connects LCA 400 to a steering knuckle. FIG. 13 shows a side view of adapter 420, in accordance with one embodiment of the present invention. As specified above, adapter 420 includes a Heim or ball joint conversion adapter 420. Adapter 420 has a first conical nut 422. Further, adapter 420 has a first tapered section 424 that matches the Heim joint i.e., connector 404. First tapered section 424 extends from conical nut 422. Adapter 420 has a second tapered section 426 that extends from first tapered section 424. Second tapered section 426 matches the diameter of the Heim joint i.e., connector 306 at the bottom. Adapter 420 has a conical section 428 extending further down from second tapered section 426. Conical section 428 goes through connector 404 and allows adapter 420 to sit within connector 404. Further, adapter 420 has a threaded portion 430 extending from conical section 428.

In accordance with the present invention, steering knuckle 200 can be mounted to a rear-wheel drive vehicle and a four-wheel drive vehicle (all-wheel drive vehicle). In order to connect to a rear-wheel drive vehicle (two-wheel drive vehicle), at first, hub 212 is mapped from its factory/stock location centered between adjustable UCA 300 and LCA 400 to a final placement of just below LCA 400 such that ⅓ of the overall wheel is in line with the lower ball joint. The final location of hub 212 is positioned out and away from the vehicle. Placing hub 212 out and down increases ground clearance and guarantees there is no contact with the caliper on LCA 400 when the knuckle turns right or left. Most manufacturers prevent this caliper contact by placing a “steer strap” on the knuckle, but such a technique causes a reduction in the steering radius. In order to address the above problem, a 4″ knuckle is used as the starting point to build the presently disclosed steering knuckle. First, the lifted knuckle provides more mass and material with which to work. Second, it is difficult to expect a fabricator to accurately replicate/obtain the correct dimensions of the depth of the mounting holes and placement of the hub seat in relation to the caliper mount. It is also unrealistic to expect a fabricator to accurately construct a custom hub seat.

In the present invention, hub 212 is removed from its factory location centered between the UCA 300 and LCA 400. From the 4″ lifted knuckle, steering arm 208, upper mount 206, and lower mount 210 are removed. Further, a CNC machine is used to mill down what remains until it is no more than a basic mounting plate for the hub and caliper (at this point, all the original mounts and features are removed). The location of the original UCA mount becomes the location of the new LCA mount.

Further, two standing vertical ribs meet the back of the hub at 45 degrees' angles, thus creating a point that distributes both vertical and lateral force evenly between UCA 300 and LCA 400 as if hub 212 had remained in its factory location. An internal top view of the neck shows the same geometric redundancies as those seen in a trestle bridge. Furthermore, two deep channels are cut into the back of the mounting plate for each of the two standing ribs (the side plates). Finally, the notches are provided with same width as the channels in the plate steel standing ribs are cut into the cast steel hub. Further, the hub is slid along the channel and welds it into place.

The presently disclosed steering knuckle has several advantages over the prior art. The steering knuckle is designed for lifted trucks, i.e., for large pickup trucks to which an after-market modification can be made to increase the ground clearance by several inches. The steering knuckle preserves the factory geometry and provides the desired distance in the truck lift, while not pulling the steering arms out of place. The steering knuckle can be used with a two-wheel-drive (2WD) vehicle, and/or a four-wheel-drive (4WD) vehicle, with gears or a chain to transfer motion from the vehicle's constant velocity (CV) shaft to the wheels.

A person skilled in the art appreciates that the railroad safety system can come in a variety of shapes and sizes depending on the need and comfort of the user. Further, many changes in the design and placement of components may take place without deviating from the scope of the presently disclosed steering knuckle.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A steering knuckle, comprising:
a vertical arm;
an upper mount positioned at said vertical arm, wherein said upper mount comprises an upper control arm;
a steering arm positioned at said vertical arm;
a lower mount positioned at said vertical arm, wherein said lower mount comprises a lower control arm; and
a hub positioned at the bottom of said vertical arm,
wherein said hub mounts outside of attachment points of said upper control arm and said lower control arm in order to keep the same distance between said upper mount and said lower mount, and said steering arm to maintain a factory geometry.

2. The steering knuckle of claim 1, further comprises vertical ribs to meet at the back of said hub at 45 degrees to create a point that distributes both vertical force and lateral force evenly between said upper control arm and said lower control arm as if said hub remained in its factory geometry.

3. The steering knuckle of claim 1, further comprises an access panel to provide access to an interior of said steering knuckle.

4. The steering knuckle of claim 1, wherein said upper control arm comprises dual upper control mounts, and wherein said dual upper control mounts comprise dual reservoir shock mounts.

5. The steering knuckle of claim 3, wherein said access panel comprises a gear mechanism, and wherein said gear mechanism transfers motion from a vehicle's constant velocity (CV) shaft to a vehicle's wheel.

6. The steering knuckle of claim 5, further comprises a power train unit, wherein said power train unit transfers power from internal mechanisms of said steering knuckle into a hub assembly through the use of a pinion and spider gears of said gear mechanism.

7. The steering knuckle of claim 1, wherein said upper control arm comprises U-shaped member with a connector, wherein said connector comprises a Heim joint, and wherein said connector receives a ball joint conversion adapter.

8. The steering knuckle of claim 7, wherein said ball joint conversion adapter comprises a conical nut, a first tapered section extending from said conical nut, a second tapered section extending from said first tapered section, and a conical section extending from said second tapered section.

9. The steering knuckle of claim 7, wherein said U-shaped member comprises an adjustable nut, wherein said adjustable nut is rotated to adjust the length of said upper control arm.

10. The steering knuckle of claim 1, wherein said lower control arm comprises U-shaped member with a connector, wherein said connector comprises a Heim joint, and wherein said connector receives a ball joint conversion adapter.

11. The steering knuckle of claim 10, wherein said U-shaped member comprises an adjustable nut, wherein said adjustable nut is rotated to adjust the length of said lower control arm.

12. The steering knuckle of claim 10, wherein said ball joint conversion adapter comprises a conical nut, a first tapered section extending from said conical nut, a second tapered section extending from said first tapered section, and a conical section extending from said second tapered section.

13. A steering knuckle, comprising:
a vertical arm;
an upper mount positioned at said vertical arm, wherein said upper mount comprises an upper control arm, said upper control arm comprises a first U-shaped member with a connector, wherein said connector comprises a Heim joint, and wherein said connector receives a ball joint conversion adapter;
a steering arm positioned at said vertical arm;
a lower mount positioned at said vertical arm, wherein said lower mount comprises a lower control arm, said lower control arm comprises a second U-shaped member with a connector, wherein said connector comprises a Heim joint, and wherein said connector receives a ball joint conversion adapter; and
a hub positioned at the bottom of said vertical arm,
wherein said hub mounts outside of attachment points of said upper control arm and said lower control arm in order to keep the same distance between said upper mount and said lower mount, and said steering arm to maintain a factory geometry.

14. The steering knuckle of claim 13, further comprises vertical ribs to meet at the back of said hub at 45 degrees to create a point that distributes both vertical force and lateral force evenly between said upper control arm and said lower control arm as if said hub remained in its factory geometry.

15. The steering knuckle of claim 13, further comprises an access panel to provide access to an interior of said steering knuckle.

16. The steering knuckle of claim 13, wherein said upper control arm comprises dual upper control mounts, and wherein said dual upper control mounts comprise dual reservoir shock mounts.

17. The steering knuckle of claim 13, wherein said access panel comprises a gear mechanism, and wherein said gear mechanism transfers motion from a vehicle's constant velocity (CV) shaft to a vehicle's wheel, wherein said steering knuckle further comprises a power train unit, and wherein said power train unit transfers power from internal mechanisms of said steering knuckle into a hub assembly through the use of a pinion and spider gears of said gear mechanism.

18. The steering knuckle of claim 13, wherein said first U-shaped member comprises an adjustable nut, and wherein said adjustable nut is rotated to adjust the length of said upper control arm.

19. The steering knuckle of claim 13, wherein said second U-shaped member comprises an adjustable nut, and wherein said adjustable nut is rotated to adjust the length of said lower control arm.

20. A method of providing a steering knuckle, said method comprising the steps of:
providing a vertical arm;
providing an upper mount positioned at said vertical arm, said upper mount comprising an upper control arm;
providing a steering arm positioned at said vertical arm;
providing a lower mount positioned at said vertical arm, said lower mount comprising a lower control arm;
providing a hub positioned at the bottom of said vertical arm; and
mounting said hub outside of attachment points of said upper control arm and said lower control arm in order to keep the same distance between said upper mount and said lower mount, and said steering arm for maintaining a factory geometry.
